(19) United States
(12) Patent Application Publication
(10) Pub. No.: US 2016/0105869 A1
(43) Pub. Date: Apr. 14, 2016

(54) TECHNIQUES FOR BACKGROUND PUBLIC LAND MOBILE NETWORK (BPLMN) SEARCH MANAGEMENT

(71) Applicant: QUALCOMM Incorporated, San Diego, CA (US)

(72) Inventors: Vishnu Karakkad Kesavan NAMBOODIRI, Kannur (IN); Bipin Kumar JAISWAL, Hyderabad (IN); Nilotpal DHAR, Hyderabad (IN); Pankaj BANSAL, Hyderabad (IN)

(21) Appl. No.: 14/820,366

(22) Filed: Aug. 6, 2015

Related U.S. Application Data
(60) Provisional application No. 62/061,555, filed on Oct. 8, 2014.

(51) Int. Cl. H04W 72/02; H04W 68/00; H04W 76/04

(52) U.S. Cl. CPC H04W 72/02; H04W 76/048; H04W 68/00; H04W 84/042

(57) ABSTRACT

Aspects of managing background public mobile network (BPLMN) searches are described. For example, in an aspect, a user equipment (UE) may determine whether one or more segments of a frequency acquisition from a prior discontinuous reception (DRX) cycle remain to be completed and whether the one or more segments of the frequency acquisition may be performed in a remaining portion of the current DRX cycle. If so, the UE may be configured to perform the one or more segments of the frequency acquisition when the identified remaining portion of the current DRX cycle provides sufficient time.

### CLAIM OF PRIORITY

This is an application claiming priority to Provisional Application No. 62/061,555 entitled “TECHNIQUES FOR BACKGROUND PUBLIC LAND MOBILE NETWORK (BPLMN) SEARCH MANAGEMENT” filed on Oct. 8, 2014, and assigned to the assignee hereof and hereby expressly incorporated by reference herein.

### BACKGROUND

The described aspects relate generally to wireless communication systems. More particularly, the described aspects relate to techniques for BPLMN search management.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks. Furthermore, UMTS supports multiple radio access bearer (multi-RAB) capability, which allows simultaneous network communication with a user equipment (UE) over two or more radio access bearers. Therefore, in an aspect, multi-RAB functionality in UMTS allows for a UE to concurrently transmit and receive packet-switched (PS) and circuit-switched (CS) data.

A UE may perform a background public land mobile network (BPLMN) search to search for higher priority PLMNs (HPLMN search) or available PLMNs (Manual search) without missing pages. A BPLMN search is triggered when the UE is in idle mode (e.g., no call is in progress or no ongoing data transmission activities) in between paging occasions, e.g., the search may be suspended prior to a paging occasion to listen to the paging. A BPLMN search for multiple frequency bands may span across multiple discontinuous reception (DRX) cycles, although a search for a candidate carrier in each frequency band is performed in a single DRX cycle. For example, for each candidate carrier associated with a respective PLMN, the BPLMN searching may include scanning a respective frequency band for signals advertising the corresponding PLMN, performing synchronization, frame time, and scrambling code identification, all in a single respective DRX cycle.

Therefore, there is a desire for techniques for more efficiently managing BPLMN searches during DRX cycles.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents examples of techniques for managing BPLMN searches. An example method may include determining an end of a paging occasion in a current discontinuous reception (DRX) cycle. In addition, the example method may include determining whether one or more segments of a first frequency acquisition from a prior DRX cycle remain to be completed. Further, the example method may include determining whether the one or more segments of the first frequency acquisition may be performed in a remaining portion of the current DRX cycle. Further still, the example method may include performing the one or more segments of the first frequency acquisition when the identified remaining portion of the current DRX cycle provides sufficient time. The example method may further include saving results from the one or more segments of the first frequency acquisition.

An example apparatus for managing BPLMN searches may include a transceiver configured to tune to one or more frequencies to search BPLMNs. In addition, the example apparatus may include one or more processors communicatively coupled to the transceiver and configured to determine an end of a paging occasion in a current DRX cycle, determine whether one or more segments of a first frequency acquisition from a prior DRX cycle remain to be completed, determine whether the one or more segments of the first frequency acquisition may be performed in a remaining portion of the current DRX cycle, perform the one or more segments of the first frequency acquisition when the identified remaining portion of the current DRX cycle provides sufficient time and save results from the one or more segments of the first frequency acquisition. Further still, the example apparatus may include a memory coupled to the one or more processors to store the results from the one or more segments of the first frequency acquisition.

Another example apparatus for managing BPLMN searches may include means for determining an end of a paging occasion in a current DRX cycle. In addition, the example apparatus may include means for determining whether one or more segments of a first frequency acquisition from a prior DRX cycle remain to be completed. Further, the example apparatus may include means for determining whether the one or more segments of the first frequency acquisition may be performed in a remaining portion of the current DRX cycle. Further still, the example apparatus may include means for performing the one or more segments of the first frequency acquisition when the identified remaining portion of the current DRX cycle provides sufficient time. The example apparatus may further include means for saving results from the one or more segments of the first frequency acquisition.

An example computer-readable medium storing computer executable code for managing BPLMN searches may include code for determining an end of a paging occasion in a current DRX cycle. The example computer-readable medium may additionally include code for determining whether one or more segments of a first frequency acquisition from a prior DRX cycle remain to be completed. Further, the example computer-readable medium may include code for determining whether the one or more segments of the first frequency acquisition may be performed in a remaining portion of the current DRX cycle. Further still, the example computer-readable medium may include code for performing the one or more segments of the first frequency acquisition when the identified remaining portion of the current DRX cycle provides sufficient time. The example computer-readable medium may further include code for saving results from the one or more segments of the first frequency acquisition.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating a wireless communication system in which BPLMN search management may be implemented;

FIG. 2 is a diagram illustrating one or more BPLMN searches performed in DRX cycles;

FIG. 3A is a flow chart of aspects of a method for managing BPLMN searches; and

FIG. 3B is another flow chart of aspects of a method for managing BPLMN searches.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

While operating in idle mode, a UE may perform one or more background public land mobile network (BPLMN) searches to select an available cell. In some aspects, the UE may perform one or more segments of a BPLMN search for signals from a respective candidate carrier associated with a respective PLMN across multiple discontinuous reception (DRX) cycles. In some examples, a BPLMN search for each respective candidate carrier associated with a respective PLMN may include, but is not limited to, any combination of the following segments: a signal synchronization attempt on a frequency for a radio access technology (e.g., a slot synchronization using a primary synchronization channel (SCH)), a frame timing and scrambling code identification, a pseudo number search and/or multipath determination, and a confirmation of an identified candidate PLMN. As such, as referenced herein, a segment of a frequency acquisition may refer to a fragmented part of a portion of the BPLMN search. Also, as referenced herein, a portion of an overall (e.g., multiple carrier candidate) BPLMN search that relates to a respective candidate carrier may be referred to as a frequency acquisition.

Each DRX cycle may include, for example, a time period including a first portion during which the UE may be configured to monitor for paging information during a paging occasion and a second portion, after the paging occasion, during which the UE may be configured to perform a frequency acquisition associated with the BPLMN search within a frequency band. In prior solutions, a remaining portion of the DRX cycle, e.g., after the frequency acquisition and before the next paging occasion, may not provide sufficient time for another complete frequency acquisition and thus the next frequency acquisition is delayed until after the next paging occasion. According to the present aspects, however, such a remaining portion of the DRX cycle may be used for performing one or more segments of another frequency acquisition. As such, according to the present aspects, the UE is configured to perform at least a part of two different frequency acquisitions during a single DRX cycle, e.g., one or more segments of one frequency acquisition immediately after the paging occasion, and one or more segments of another frequency acquisition in a remaining portion of the DRX cycle.

Further, the UE may also be configured to save the search results of the one or more segments of the frequency acquisition and wait for a next DRX cycle to perform the rest of the frequency acquisition. Accordingly, in the next DRX cycle, the UE is configured to check whether or not a frequency acquisition is in already in progress, and if so, retrieve the saved search results and continue with a next segment of the “in progress” frequency acquisition.

As such, according to the present aspects, a frequency acquisition of a BPLMN search can be split into multiple segments, and one or more segments of two different frequency acquisitions may be performed in one DRX cycle, which may result in more efficient use of a DRX cycle and a BPLMN search being completed faster and more efficiently.

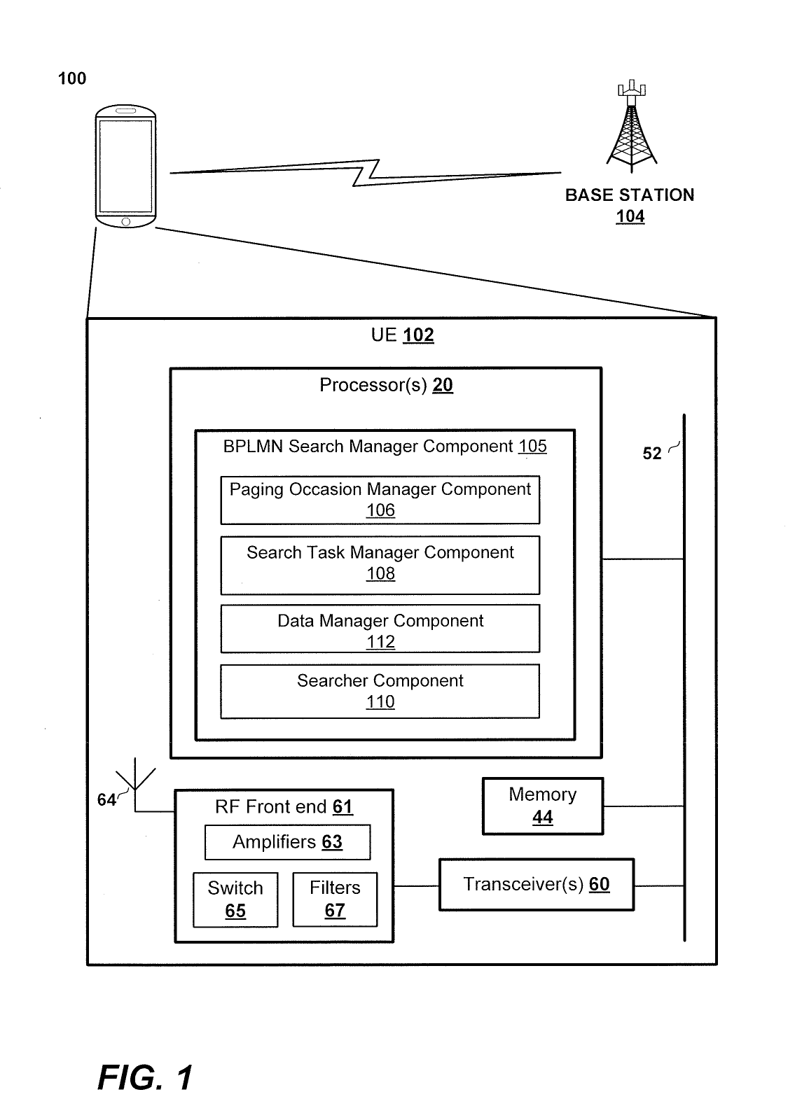

Referring to FIG. 1, a wireless communication system 100 may include a UE 102 having one or more components for background public land mobile network (BPLMN) search management, e.g., BPLMN search manager component 105, configured to control performance of one or more segments of two different frequency acquisitions of a BPLMN search in one DRX cycle. BPLMN search manager component 105 may be implemented on UE 102 in hardware, such as in one or more processor modules, or in software such as in computer-readable code or instructions stored on a computer readable medium and executed by one or more processors, or as some combination of both. In an aspect, the term “component” as used herein may be one of the parts that make up a system, may be implemented as hardware, software, firmware, or any combination thereof, and may be further divided into other components. By operating in communication with base station 104, UE 102 may receive or transmit data with a current PLMN associated with base station 104. If there is no data communication between base station 104 and UE 102, UE 102 may be configured to operate in idle mode to save power consumption. In the idle mode, UE 102 may be configured to periodically wake up in periodic DRX cycles to monitor at least one paging channel associated with base station 104. As referenced herein, the term “wake up” may refer to one or more operations that include activating at least one radio frequency (RF) component, such as a transceiver or receiver, to monitor the paging channel for receipt of paging signals.

According to the present aspects, the UE 102 may include one or more processors 20 coupled to a memory 44 and transceiver 60 via at least one bus 52. One or more processors 20 may execute various components for managing a BPLMN search as described herein. For instance, in some aspects, the various components related to BPLMN search management may be executed by a single processor, while in other aspects different ones of the components may be executed by a combination of two or more different processors. For example, in an aspect, the one or more processors 20 may include any one or any combination of a modem baseband processor, or a digital signal processor, or a transmit processor, or a transceiver processor. In particular, the one or more processors 20, such as a modem baseband processor, may execute BPLMN search manager component 105 configured to manage BPLMN search.

As depicted, BPLMN search manager component 105 may include a paging occasion manager component 106 configured to determine an end of a paging occasion in a current DRX cycle. Paging occasion manager component 106 may be implemented on UE 102 in hardware, such as in one or more processor modules, or in software such as in computer-readable code or instructions stored on a computer readable medium and executed by one or more processors, or as some combination of both. That is, when UE 102 finishes monitoring the paging channel and enters an inactive period of the current DRX cycle, paging occasion manager component 106 may determine that the paging occasion of the current DRX cycle has ended. A notification of the end of the paging occasion may be indicated to a search task manager component 108 of BPLMN search manager component 105.

Upon the notification of the end of the paging occasion, search task manager component 108 may be configured to determine whether one or more segments of a first frequency acquisition from a prior DRX cycle remain to be completed. Search task manager component 108 may be implemented on UE 102 in hardware, such as in one or more processor modules, or in software such as in computer-readable code or instructions stored on a computer readable medium and executed by one or more processors, or as some combination of both. That is, search task manager component 108 may be configured to check a database, e.g., memory 44, for search results to determine if there are any search results indicating a partially performed frequency acquisition. If so, search task manager component 108 may be configured to determine that at least one segment of the first frequency acquisition has been performed in a prior DRX cycle and the other segments of the first frequency acquisition remain to be completed in the current DRX cycle. If there is no segment of the first frequency acquisition to be completed, search task manager component 108 may be configured to start another frequency acquisition in the current DRX cycle.

Further, when a determination is made that one or more segments of the first frequency acquisition remain to be completed, search task manager component 108 may be further configured to determine whether the remaining one or more segments of the first frequency acquisition can be performed in a remaining portion of the current DRX cycle. That is, to make such determination, search task manager component 108 may be configured to estimate the duration of the remaining portion of the current DRX cycle and the duration of the remaining one or more segments of the first frequency acquisition. In an aspect, search task manager component 108 may determine that one or more previously performed segments of the first frequency acquisition have failed based on search results of the previously performed segments. Search task manager component 108 may then be configured to abort the remaining one or more segments of the first frequency acquisition and start the next frequency acquisition sequentially scheduled afterwards.

If the duration of the remaining portion of the current DRX cycle is equal to or greater than the duration of the remaining one or more segments of the first frequency acquisition, search task manager component 108 may be configured to instruct searcher component 110 to perform the one or more segments of the first frequency acquisition in the current DRX cycle. Searcher component 110 may be implemented on UE 102 in hardware, such as in one or more processor modules, or in software such as in computer-readable code or instructions stored on a computer readable medium and executed by one or more processors, or as some combination of both. In other words, in an aspect, search task manager component 108 may be configured to schedule searcher component 110 to perform as many of the remaining one or more segments of the first frequency acquisition as possible in the remaining portion of the current DRX cycle. In other aspects, search task manager component 108 may schedule at least a next segment of the remaining one or more segments of the first frequency acquisition, and then may re-evaluate a subsequent remaining portion of the DRX cycle and whether sufficient time exists for a subsequent one of the remaining one or more segments of the first frequency acquisition. If the duration of the remaining portion of the current DRX cycle is less than the duration of the one or more segments of the first frequency acquisition, search task manager component 108 may instruct searcher component 110 to enter an inactive period and wait for a next DRX cycle to perform the remaining segments of the first frequency acquisition. In other words, in an aspect, search task manager component 108 may be configured to instruct searcher component 110 to enter an inactive period when a next one of the remaining one or more segments of the first frequency acquisition cannot be performed in the remaining portion of the current DRX cycle.

When instructed by search task manager component 108, searcher component 110 may be configured to perform the one or more segments of the first frequency acquisition when the remaining portion of the current DRX cycle provides sufficient time, e.g., the remaining portion of the current DRX cycle is equal to or greater than the duration of the one or more segments of the first frequency acquisition. As noted above, in some examples, after searcher component 110 performs one of the one or more segments of the first frequency acquisition, search task manager component 108 may be configured to determine whether any remaining portion of the current DRX cycle provides sufficient time for performing at least another segment of the first frequency acquisition.

Further, a data manager component 112 of BPLMN search manager component 105 may be configured to save search results from the one or more segments of the first frequency acquisition to a database, e.g., memory 44, associated with UE 102. Data manager component 112 may be implemented on UE 102 in hardware, such as in one or more processor modules, or in software such as in computer-readable code or instructions stored on a computer readable medium and executed by one or more processors, or as some combination of both. As such, data manager component 112 may be configured to store and/or generate search results associated with respective segments, and/or an overall result of the first frequency acquisition based on search results of segments of the first frequency acquisition performed in different DRX cycles.

In some aspects, when the first frequency acquisition is completed with a current DRX cycle, search task manager component 108 may be further configured to determine whether the remaining portion of the current DRX cycle provides sufficient time for performing a second frequency acquisition or at least a segment of the second frequency acquisition. For example, in this case, the remaining portion of the DRX cycle corresponds to a time period between a time when the first frequency acquisition is completed and a time corresponding to a beginning of a next paging occasion (or, in some aspects, a time that is backed off of the beginning of he next paging occasion, e.g., to allow UE 102 headroom to reconfigure itself to monitor the paging channel).

If there is time remaining in the current DRX cycle, search task manager component 108 may instruct searcher component 110 to perform at least one segment of the second frequency acquisition, e.g., one or more segments that may be completed within the time remaining. Thus, UE 102 specially configured with BPLMN search manager component 105 may efficient utilize the time in a DRX cycle between paging occasions to perform one or more segments of at least two different frequency acquisitions associated with a BPLMN search.

In some aspects, UE 102 also may be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Moreover, in an aspect, UE 102 may include one or more transceivers 60 for receiving and transmitting radio transmissions. For instance, the one or more transceivers 60 may be configured to receive different kinds of radio signals, e.g., cellular, WiFi, Bluetooth, GPS, etc. For example, in an aspect, one or more transceivers 60 may be in communication with or connected to a radio frequency (RF) front end 61 defined by, for instance one or more power amplifiers 63, one or more band specific filters 67, and one or more antennas 64. For example, one or more transceivers 60 may include a receiver and may include hardware and/or software code executable by one or more processors 20 for receiving signals within one or more frequency bands for use in identifying candidate carriers and performing frequency acquisitions associated with a BPLMN search. Additionally, for example, transceiver 60 may also include a transmitter for transmitting signals to base station 104, e.g., such as registration messages to register with a new PLMN identified based on operation of BPLMN search manager component 105.

In some aspects, UE 102 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 102 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, base station 104 may be a macrocell, picocell, femtocell, relay, Node B, mobile Node B, UE (e.g., communicating in peer-to-peer or ad-hoc mode with UE 102), or substantially any type of component that can communicate with UE 102 to provide wireless network access at the UE 102.

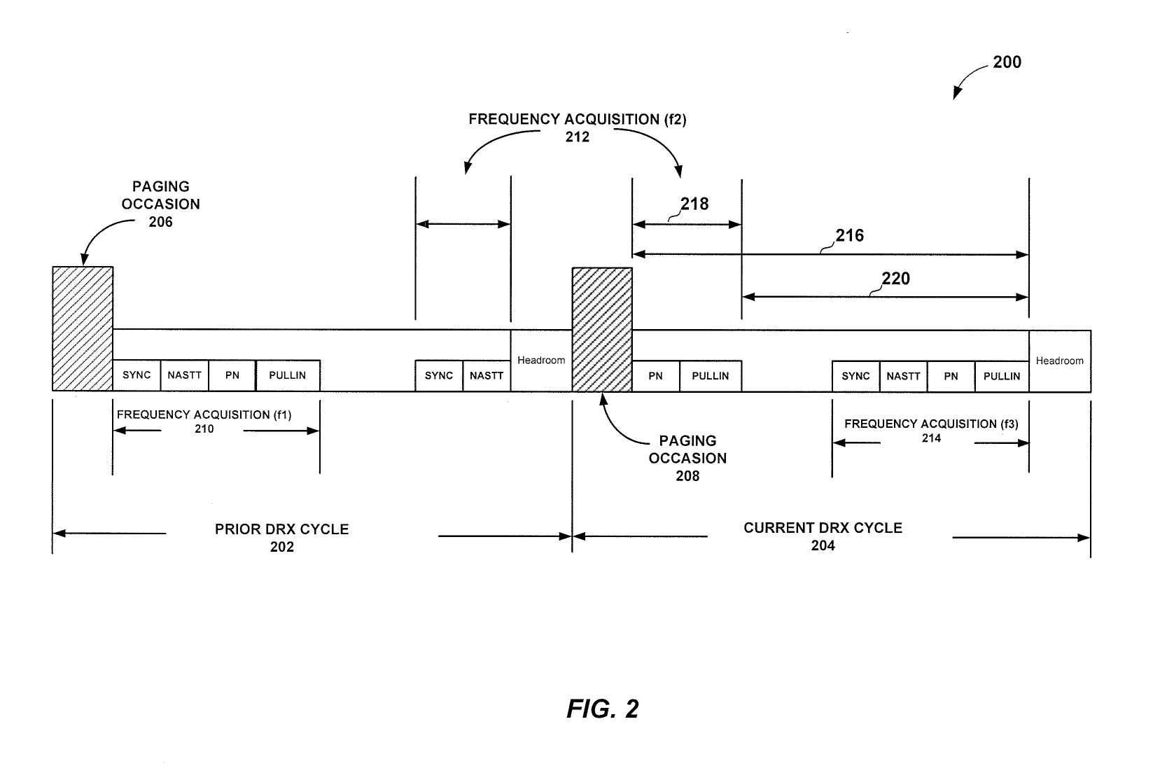

Referring to FIG. 2, an example timeline 200 illustrates segmented portions of a same frequency acquisition performed in different DRX cycles as may be performed by UE 102 operating BPLMN search manager component 105 as described in FIG. 1. As depicted, one or more segments of separate frequency acquisitions associated with a BPLMN search for respective candidate carrier frequencies f1, f2, and f3, e.g., frequency acquisition 210, 212, and 214, may be performed during prior DRX cycle 202 and current DRX cycle 204. In particular, one or more segments of a respective frequency acquisition may be performed in two different DRX cycles. For example, some segments of frequency acquisition 212 were performed in prior DRX cycle 202 and the other segments of frequency acquisition 212 may be performed in current DRX cycle 204.

In an aspect, each of frequency acquisitions 210, 212, and 214 may at least include four segments. The four segments may respectively refer to a first segment illustrated as “SYNC” block for slot synchronization with a primary synchronization channel between base station 104 and UE 102, a second segment illustrated as “NASTT” block for frame timing and scrambling code identification, a third segment illustrated as “PN” block for a pseudo number (PN) search, and a fourth segment illustrated as “PULLIN” block for reconfirming searcher peaks using a rake receiver. A PN search may refer to a search to find multiple paths of a same primary scrambling code (PSC) and same frequency signal reaching the UE.

During current DRX cycle 204, paging occasion manager component 106 may be configured to determine an end of a paging occasion 208. That is, when UE 102 finishes monitoring the paging channel and enters an inactive period of current DRX cycle 204, paging occasion manager component 106 may determine that paging occasion 208 has ended. A notification of the end of paging occasion 208 may be indicated to search task manager component 108.

Upon the notification of the end of the paging occasion, search task manager component 108 may be configured to determine whether one or more segments of a first frequency acquisition from a prior DRX cycle remain to be completed. That is, search task manager component 108 may be configured to check a database, e.g., memory 44, for the search results to determine if there are any partial search results indicating a partially performed frequency acquisition. For example, as illustrated in FIG. 2, search task manager component 108 may determine that the first and second segments of frequency acquisition 212, e.g., “SYNC” and “NASTT,” were performed in prior DRX cycle 202 and the third and fourth segments of frequency acquisition 212, e.g., “PN” and “PULLIN,” remain to be completed in current DRX cycle 204. In an aspect, search task manager component 108 may be configured to determine that one or more of the first and second segments have failed based on search results stored in the database. Search task manager component 108 may be configured to abort the remaining segments of the first frequency acquisition (e.g., “PN” and “PULLIN” of frequency acquisition 212) and start the next frequency acquisition (e.g., frequency acquisition 214).

Further, search task manager component 108 may be configured to determine whether the remaining one or more segments of the first frequency acquisition can be performed in a first remaining portion 216 of the current DRX cycle. For example, search task manager component 108 may estimate the duration of the first remaining portion 216 of current DRX cycle 204 and the duration 218 of the remaining segments, e.g., the third and fourth segments of frequency acquisition 212. Based on the estimation, in one example where the time left in the DRX cycle is greater than a duration of at least one next segment, search task manager component 108 may determine that the first remaining portion 216 of current DRX cycle 204 provides sufficient time for the third and fourth segments of frequency acquisition 212. Search task manager component 108 may then instruct searcher component 110 to perform the third and fourth segments of frequency acquisition 212.

When the third and fourth segments of frequency acquisition 212 are performed by searcher component 110, data manager component 112 of BPLMN search manager component 105 may then save search results from the third and fourth segments to memory 44, for example, along with identification information that identifies the particular search.

In some aspects, when frequency acquisition 212 is completed, search task manager component 108 may further determine whether a second remaining portion 220 of current DRX cycle 204, after the third and fourth segments of frequency acquisition 212 are performed, provides sufficient time for performing at least one segment of frequency acquisition 214. As illustrated in FIG. 2, search task manager component 108 may determine that complete frequency acquisition 214 may be performed in the second remaining portion 220 of current DRX cycle 204. Thus, BPLMN search manager component 105 and/or search task manager component 108 may initiate performance of frequency acquisition 214 during the second remaining portion 220 of current DRX cycle 204.

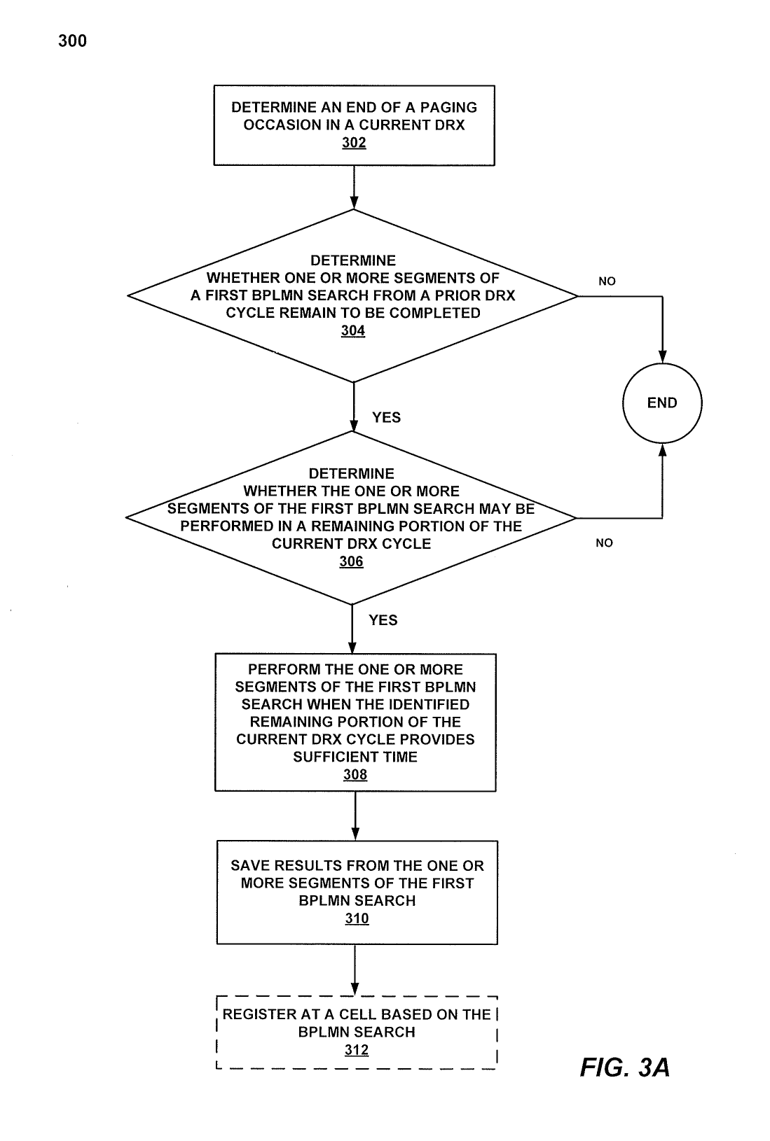

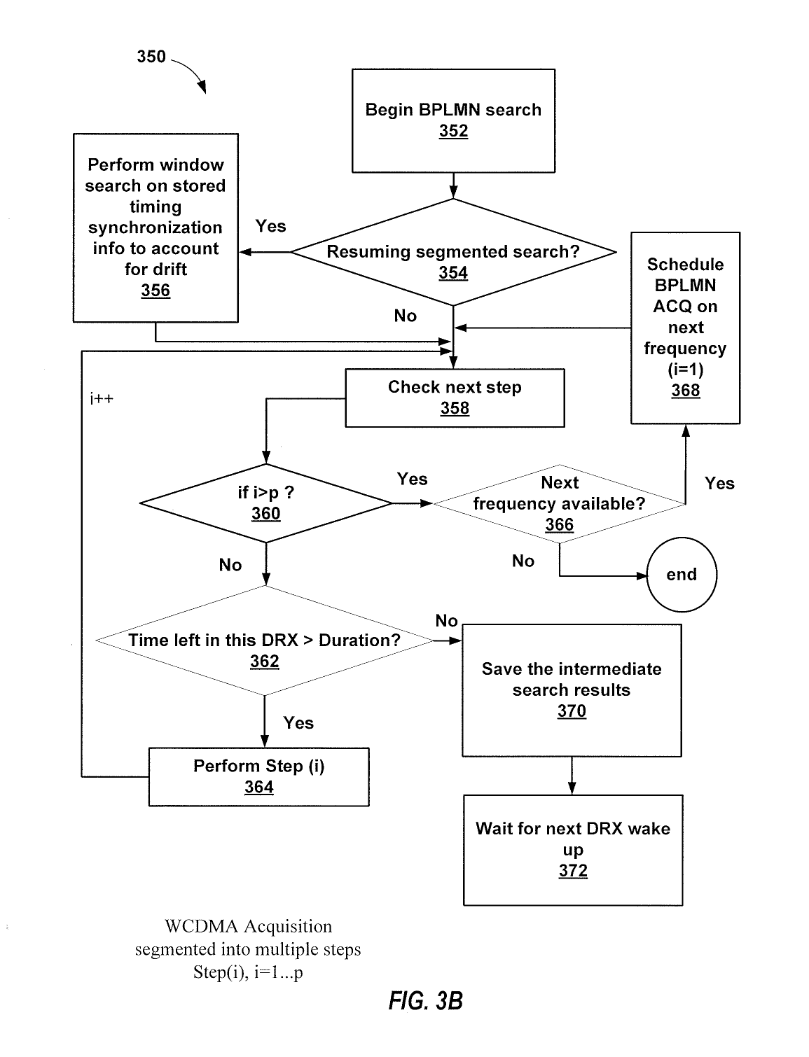

Referring to FIG. 3A, aspects of a method 300 for managing BPLMN search may be performed by BPLMN search manager component 105 of UE 102 of FIG. 1 and the components thereof. In an aspect, BPLMN search manager component 105 may perform method 300 when operating in one or more DRX cycles. More particularly, aspects of method 300 may be performed by BPLMN search manager component 105 including paging occasion manager component 106, search task manager component 108, searcher component 110, and data manager component 112 as shown in FIG. 1.

At 302, method 300 includes determining an end of a paging occasion in a current discontinuous reception (DRX) cycle. That is, during current DRX cycle 204, paging occasion manager component 106 may be configured to determine an end of a paging occasion 208. In other words, when UE 102 finishes monitoring the paging channel and enters an inactive period of current DRX cycle 204, paging occasion manager component 106 may determine that paging occasion 208 has ended. In an aspect, paging occasion manager component 106 may determine the end of paging occasion 208 based on a predetermined paging pattern provided by a network entity, e.g., base station 104. A notification of the end of paging occasion 208 may be indicated to search task manager component 108.

At 304, method 304 includes determining whether one or more segments of a first frequency acquisition from a prior DRX cycle remain to be completed. That is, upon the notification of the end of the paging occasion, search task manager component 108 may be configured to determine whether one or more segments of a first frequency acquisition from a prior DRX cycle remain to be completed. In some aspects, search task manager component 108 may be configured to check a database, e.g., memory 44, for the search results to determine if there is any search results indicating a partially performed BPLMN search. For example, as illustrated in FIG. 2, search task manager component 108 may determine that the first and second segments of frequency acquisition 212, e.g., “SYNC” and “NASTT,” were performed in prior DRX cycle 202 and the third and fourth segments of frequency acquisition 212, e.g., “PN” and “PULLIN,” remain to be completed in current DRX cycle 204. In an aspect, such determination may be made based on identification information associated with each of the segments (hereinafter “segment identification”) and stored in the database, e.g., memory 44. That is, segment identification corresponding to the search results of the partially performed BPLMN search may be stored in the database. Since all segments are to be performed sequentially, search task manager component 108 may determine what segments have been performed by examining the database for stored segment identification and determine the segments to be performed based on the sequence. If there is no segment of the first frequency acquisition from prior DRX cycle 202 to completed in current DRX cycle 204, e.g., the first frequency acquisition was completed in prior DRX cycle 202, search task manager component 108 may initiate another frequency acquisition, if necessary, e.g., frequency acquisition 214.

At 306, method 300 includes determining whether the one or more segments of the first frequency acquisition may be performed in a remaining portion of the current DRX cycle. That is, search task manager component 108 may be configured to determine whether the one or more segments of the first frequency acquisition can be performed in a remaining portion of the current DRX cycle. For example, search task manager component 108 may estimate the duration of the remaining portion of current DRX cycle 204 and the duration of the third and fourth segments of frequency acquisition 212. In an aspect, a duration of each segment is predetermined to be a fixed value, e.g., 35 milliseconds for “SYNC,” 5 milliseconds for “PN,” 35 milliseconds for “NASTT,” and up to 120 milliseconds for “PULLIN.” The respective durations for the segments may also be stored in memory 44 such that search task manager component 108 may estimate the durations accordingly. Based on the estimation, search task manager component 108 may determine that the remaining portion of current DRX cycle 204 provides sufficient time for the third and fourth segments of frequency acquisition 212. Search task manager component 108 may then instruct searcher component 110 to perform the third and fourth segments of frequency acquisition 212.

In some aspects, if the duration of the remaining portion of current DRX cycle 204 is less than the duration of the third and fourth segments of frequency acquisition 212, search task manager component 108 may instruct searcher component 110 to enter an inactive period and wait for a next DRX cycle to perform the remaining segments of frequency acquisition 212.

At 308, method 300 includes performing the one or more segments of the first frequency acquisition when the identified remaining portion of the current DRX cycle provides sufficient time. That is, searcher component 110 may be configured to perform the third and fourth segments of frequency acquisition 212. For example, in performing “PN,” searcher component 110 may be configured to tune transceiver 60 to a frequency corresponding to a cell to find multiple paths from the cell within a predetermined time window. Further to the example, in performing “PULLIN,” searcher component 110 may provide the information of the multiple paths to transceiver 60, which may include a rake receiver that tracks the respective energy of the cell on the multiple paths. Each of the multiple paths may be associated with a finger of the rake receiver.

At 310, method 300 includes saving results from the one or more segments of the first frequency acquisition. That is, when the third and fourth segments of frequency acquisition 212 are performed by searcher component 110, data manager component 112 of UE 102 may then save search results from the third and fourth segments. The search results for “PN” may include the information associated with the multiple paths of the cell and corresponding energy of the each cell. The search results of “PULLIN” may include corresponding energy of a finger of the rake receiver (i.e., a sub-receiver).

At 312, method 312 includes registering at a cell based on the result of the BPLMN search that may indicate at least one PLMN that meets a cell reselection threshold. For example, transceiver 60 may be configured to tune to one frequency to register at a suitable cell or PLMN based on the result of the BPLMN search. UE 102 may send a registration request to the suitable cell accordingly.

FIG. 3B is another flow chart of another example of a method 350 for managing BPLMN searches. Method 350 may refer to a more specific implementation of method 300. In an aspect, UE 102 may perform method 350 when operating in DRX cycles. More particularly, aspects of method 350 may be performed by BPLMN search manager component 105 that includes paging occasion manager component 106, search task manager component 108, searcher component 110, and data manager component 112 as shown in FIG. 1.

At 352, method 350 may include BPLMN search manager component 105 beginning a BPLMN search in a current DRX cycle, e.g., current DRX cycle 204 in FIG. 2. The BPLMN search may include one or more portions that may be interchangeably referred to as one or more frequency acquisitions. Further, segments of a frequency acquisition may be sequentially referred to as step (i), in which the indicator i is value incrementing from 1 to p and p is the total number of segments included in a frequency acquisition. For example, SYNC, NASTT, PN, and PULLN may be respectively referred to as step (1) to step (4).

At 354, method 350 may include BPLMN search manager component 105 determining whether to resume a segmented search, e.g., frequency acquisition 212, in a DRX cycle, e.g., current DRX cycle 204. For example, paging occasion manager component 106 may be configured to determine an end of a paging occasion 208. Upon the end of the paging occasion, search task manager component 108 may be configured to determine whether one or more segments of a first frequency acquisition (e.g., frequency acquisition 212) from a prior DRX cycle (e.g., prior DRX cycle 202) remain to be completed. If there are one or more segments remaining to be completed, the process may continue to 356; if there is no segment remaining to be completed, the process may continue to 358.

At 356, method 350 may include BPLMN search manager component 105 performing a window search on stored timing synchronization information to account for drift occurred during paging occasion 208. A drift may be caused by reflections of wireless signals or the movement of UE 102 during paging occasion 208. Thus, a window search may be conducted by BPLMN search manager component 105 and/or transceiver 60 to find multiple paths from a cell to UE 102 within a defined window to account for the drift. The process may continue to 358.

At 358, method 350 may include BPLMN search manager component 105 checking information associated with next step (i). That is, since all segments are to be performed sequentially, search task manager component 108 may determine what segments have been performed by examining the database for stored segment identification and determine the segments to be performed based on the sequence.

At 360, method 350 may include BPLMN search manager component 105 determining if the indicator i is greater than the total number of the segments p. If the indicator i is greater than p, BPLMN search manager component 105 may determine that the current frequency acquisition has been completed and the process may continue to 366. If the indicator i is less than p, BPLMN search manager component 105 may determine that the current frequency acquisition has not been completed, and the process may continue to 361.

At 362, method 350 may include BPLMN search manager component 105 determining if time left in the current DRX cycle is equal to or greater than the duration of step (i). For example, search task manager component 108 may be further configured to determine whether the remaining one or more segments of the first frequency acquisition can be performed in a remaining portion of the current DRX cycle. If the time left in the current DRX cycle is equal to or greater than the duration of step (i), process may continue to 364. If the time left in the current DRX cycle is less than the duration of step (i), process may continue to 370.

At 366, method 350 may include BPLMN search manager component 105 determining whether next frequency is available for acquisition. In other words, BPLMN search manager component 105 may determine if all frequency acquisitions of the current BPLMN search have been completed. If there is no next frequency for acquisition, BPLMN search manager component 105 may determine the current BPLMN search is completed and the process ends. If there is a next frequency for acquisition, BPLMN search manager component 105 may determine that the current BPLMN search has not been completed and process may continue to 368

At 368, method 350 may include BPLMN search manager component 105 scheduling the next frequency acquisition and the process may revert to 358. In an aspect, frequency acquisitions of a band may be sequentially scheduled.

At 364, method 350 may include BPLMN search manager component 105 performing step (i) and process may revert to 358. The indicator i may increment by one after BPLMN search manager component 105 performs step (i).

At 370, method 350 may include BPLMN search manager component 105 saving the intermediate search results. That is, when the time left in the current DRX cycle is less than the duration of step (i), data manager component 112 of UE 102 may be configured to save search results from the one or more segments of the first frequency acquisition to a database associated with UE 102.

At 372, method 350 may include BPLMN search manager component 105 waiting for next DRX wake up. That is, If the duration of the remaining portion of the current DRX cycle is less than the duration of the one or more segments of the first frequency acquisition, search task manager component 108 may instruct searcher component 110 to enter an inactive period and wait for a next DRX cycle to perform the remaining segments of the first frequency acquisition. In other words, in an aspect, search task manager component 108 may be configured to instruct searcher component 110 to enter an inactive period when a next one of the remaining one or more segments of the first frequency acquisition cannot be performed in the remaining portion of the current DRX cycle.

What is claimed is:

1. A method for managing background public land mobile network (BPLMN) search, comprising:
determining an end of a paging occasion in a current discontinuous reception (DRX) cycle;
determining whether one or more segments of a first frequency acquisition from a prior DRX cycle remain to be completed;
determining whether the one or more segments of the first frequency acquisition may be performed in a remaining portion of the current DRX cycle;
performing the one or more segments of the first frequency acquisition when the identified remaining portion of the current DRX cycle provides sufficient time; and
saving results from the one or more segments of the first frequency acquisition.

2. The method of claim 1, further comprising:
determining whether the remaining portion of the current DRX cycle, after the performing of the one or more segments of the first frequency acquisition, provides sufficient time for performing a second frequency acquisition;
performing at least one segment of the second frequency acquisition based on the determining.

3. The method of claim 1, wherein the one or more segments of the first frequency acquisition include:
a first segment for slot synchronization with a primary synchronization channel,
a second segment for frame timing and scrambling code identification,
a third segment for a pseudo number (PN) search, and
a fourth segment for reconfirming searcher peaks using a rake receiver.

4. The method of claim 1, further comprising registering at a cell based on a result of the BPLMN search.

5. The method of claim 1, further comprising, after performing each of the one or more segments of the first frequency acquisition, determining whether a new remaining portion of the current DRX cycle provides sufficient time for performing at least another segment of the first frequency acquisition.

6. The method of claim 1, further comprising:
determining that one or more previously performed segments of the first frequency acquisition have failed;
aborting the one or more segments of the first frequency acquisition; and
performing a second frequency acquisition in the remaining portion of the current DRX cycle.

7. An apparatus for managing background public land mobile network (BPLMN) search, comprising
a transceiver configured to tune to one or more frequencies to search BPLMNs;
one or more processors communicatively coupled to the transceiver by one or more buses and configured to:
determine an end of a paging occasion in a current discontinuous reception (DRX) cycle;
determine whether one or more segments of a first frequency acquisition from a prior DRX cycle remain to be completed;
determine whether the one or more segments of the first frequency acquisition may be performed in a remaining portion of the current DRX cycle;
perform the one or more segments of the first frequency acquisition when the identified remaining portion of the current DRX cycle provides sufficient time; and
save results from the one or more segments of the first frequency acquisition; and
a memory coupled to the one or more processors to store the results from the one or more segments of the first frequency acquisition.

8. The apparatus of claim 7, wherein the transceiver is tuned to one of the one or more frequencies to register at a cell based on a result of the BPLMN search.

9. The apparatus of claim 7, wherein the one or more processors are further configured to:
determine whether the remaining portion of the current DRX cycle, after the performing of the one or more segments of the first frequency acquisition, provides sufficient time for performing a second frequency acquisition, and
perform at least one segment of the second frequency acquisition based on the determining.

10. The apparatus of claim 7, wherein the one or more segments of the first frequency acquisition include:
a first segment for slot synchronization with a primary synchronization channel,
a second segment for frame timing and scrambling code identification,
a third segment for a pseudo number (PN) search, and
a fourth segment for reconfirming searcher peaks using a rake receiver.

11. The apparatus of claim 7, wherein the one or more processors are further configured to determine whether a new remaining portion of the current DRX cycle provides sufficient time for performing at least another segment of the first frequency acquisition after performing each of the one or more segments of the first frequency acquisition.

12. An apparatus for managing background public land mobile network (BPLMN) search, comprising:
means for determining an end of a paging occasion in a current discontinuous reception (DRX) cycle;
means for determining whether one or more segments of a first frequency acquisition from a prior DRX cycle remain to be completed;
means for determining whether the one or more segments of the first frequency acquisition may be performed in a remaining portion of the current DRX cycle;
means for performing the one or more segments of the first frequency acquisition when the identified remaining portion of the current DRX cycle provides sufficient time; and
means for saving results from the one or more segments of the first frequency acquisition.

13. The apparatus of claim 12, further comprising:
means for determining whether the remaining portion of the current DRX cycle, after the performing of the one or more segments of the first frequency acquisition, provides sufficient time for performing a second frequency acquisition;
means for performing at least one segment of the second frequency acquisition based on the determining.

14. The apparatus of claim 12, further comprising means for registering at a cell based on a result of the BPLMN search.

15. The apparatus of claim 12, wherein the one or more segments of the first frequency acquisition include:
a first segment for slot synchronization with a primary synchronization channel,
a second segment for frame timing and scrambling code identification,
a third segment for a pseudo number (PN) search, and
a fourth segment for reconfirming searcher peaks using a rake receiver.

16. The apparatus of claim 12, further comprising means for determining whether a new remaining portion of the current DRX cycle provides sufficient time for performing at least another segment of the first frequency acquisition after performing each of the one or more segments of the first frequency acquisition.

17. A computer-readable medium storing computer executable code for managing a background public land mobile network (BPLMN) search, comprising:
code for determining an end of a paging occasion in a current discontinuous reception (DRX) cycle;
code for determining whether one or more segments of a first frequency acquisition from a prior DRX cycle remain to be completed;
code for determining whether the one or more segments of the first frequency acquisition may be performed in a remaining portion of the current DRX cycle;
code for performing the one or more segments of the first frequency acquisition when the identified remaining portion of the current DRX cycle provides sufficient time; and
code for saving results from the one or more segments of the first frequency acquisition.

18. The computer-readable medium of claim 17, further comprising code for determining whether the remaining portion of the current DRX cycle, after the performing of the one or more segments of the first frequency acquisition, provides sufficient time for performing a second frequency acquisition;
code for performing at least one segment of the second frequency acquisition based on the determining.

19. The computer-readable medium of claim 17, wherein the one or more segments of the first frequency acquisition include:
a first segment for slot synchronization with a primary synchronization channel,
a second segment for frame timing and scrambling code identification,
a third segment for a pseudo number (PN) search, and
a fourth segment for reconfirming searcher peaks using a rake receiver.

20. The computer-readable medium of claim 17, further comprising code for determining whether a new remaining portion of the current DRX cycle provides sufficient time for performing at least another segment of the first frequency acquisition after performing each of the one or more segments of the first frequency acquisition.
